(19) United States
(12) Patent Application Publication
(10) Pub. No.: US 2007/0009788 A1
(43) Pub. Date: Jan. 11, 2007

(54) Battery interface for mobile device

(76) Inventor: Auraham Avi Indik, Plantation, FL (US)

Correspondence Address: RICHARD S. ROSS, ESQ., 4801 S. UNIVERSITY DR., # 237, FT. LAUDERDALE, FL, 33328, US

(21) Appl. No.: 11/177,680

(22) Filed: Jul. 11, 2005

(51) Int. Cl. H01M 2/10

(52) U.S. Cl. 429/100; 429/123

(57) ABSTRACT

An interface for a mobile device battery is disclosed. The interface includes a U-shaped element, including an interior side and an exterior side, wherein a mobile device battery can be coupled to the interior side of the U-shaped element. The interface further includes at least one terminal coupled to the interior side of the U-shaped element, wherein each terminal contacts a battery contact of the mobile device battery when the mobile device battery is coupled to the interior side of the U-shaped element. The interface further includes at least one conductive element, wherein each conductive element is coupled to a terminal and provides a conductive contact on the exterior side of the U-shaped element for contacting a printed circuit board terminal.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

This invention generally relates to the field of mobile devices and more specifically to battery interfaces for mobile devices.

### BACKGROUND OF THE INVENTION

Mobile devices, such as cellular telephones, personal digital assistants, laptops and computer peripherals have changed the manner in which individuals work, communicate, study and perform other computer-assisted tasks by providing mobility and ease-of-use. Laptops in particular have enjoyed great success as people have a desire to work at their computers in any place they see fit. Laptops, however, typically include a touch pad or other pointing device integrated within the keyboard or in the foreground of the keyboard. As most individuals prefer a mouse over a touchpad, laptop users must carry a mouse with their laptop. With the trend toward mobile devices, a wireless mouse has become popular among laptop users.

Cellular telephones have become almost ubiquitous in the computer age. Recent surveys show that there are almost as many cellular telephones in the U.S. market as there are citizens in the country. As individuals desire to minimize the number of devices they carry, the trend is moving toward converged devices, i.e., devices that include more than one function, such as a smart-phone or a camera-phone. As such, the cellular telephone-mouse converged device fulfills the need for a wireless mouse by merging it with a cellular telephone. A cellular telephone-mouse is assembled using a cellular telephone, a wireless mouse, and a power-connecting device. The battery of the cellular telephone is removed and inserted into the connecting device, so as to provide power to the wireless mouse.

Because of the high number of different cellular telephone makes and models, cellular telephone batteries come in many shapes and sizes. Thus, it can be difficult to fabricate a connecting device for a mouse that draws power from a mobile device that is compatible with the many different batteries on the market.

Therefore a need exists to overcome the problems discussed above, and particularly for a way to facilitate the compatibility of different types of mobile telephone batteries with a mouse.

### SUMMARY OF THE INVENTION

The present invention, according to a preferred embodiment, overcomes problems with the prior art by providing a system for providing a highly compatible mouse interface for a variety of mobile telephone batteries.

In an embodiment of the present invention, an interface for a mobile telephone battery is disclosed. The interface includes a U-shaped element, including an interior side and an exterior side, wherein a mobile telephone battery can be coupled to the interior side of the U-shaped element. The interface further includes at least one terminal coupled to the interior of the U-shaped element, wherein each terminal contacts a battery contact of the mobile telephone battery when the mobile telephone battery is coupled to the interior side of the U-shaped element. The interface further includes at least one conductive element, wherein each conductive element is coupled to a terminal and provides a conductive contact on the exterior side of the U-shaped element for contacting a printed circuit board terminal.

In yet another embodiment of the present invention, a mobile telephone battery assembly is disclosed. The mobile telephone battery assembly includes a mobile telephone battery including at least one battery contact. The mobile telephone battery assembly includes an interface for the mobile telephone battery, comprising: a U-shaped element, including an interior side and an exterior side, wherein the mobile telephone battery is coupled to the interior side of the U-shaped element; at least one terminal coupled to the interior of the U-shaped element, wherein each terminal contacts a battery contact of the mobile telephone battery; and at least one conductive element, wherein each conductive element is coupled to a terminal and provides a conductive contact on the exterior side of the U-shaped element for contacting a printed circuit board terminal.

In yet another embodiment of the present invention, a mobile device is disclosed. The mobile device includes a mouse device including a printed circuit board and at least one terminal for the printed circuit board. The mobile device further includes a mobile telephone for coupling with the mouse device and a mobile telephone battery including at least one battery contact. The mobile device further includes an interface for the mobile telephone battery, comprising: a U-shaped element, including an interior side and an exterior side, wherein the mobile telephone battery is coupled to the interior side of the U-shaped element; at least one terminal coupled to the interior of the U-shaped element, wherein each terminal contacts a battery contact of the mobile telephone battery; and at least one conductive element, wherein each conductive element is coupled to a terminal and provides a conductive contact on the exterior side of the U-shaped element for contacting a terminal for the printed circuit board.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings.

FIG. 1 is an illustration showing a perspective view of a mobile telephone battery assembly, according to one embodiment of the present invention.

FIG. 2 is an illustration showing a side view of the mobile telephone battery assembly of FIG. 1, according to one embodiment of the present invention.

FIG. 3 is an illustration showing a side view of a mobile telephone battery assembly, according to one embodiment of the present invention.

FIG. 4 is an illustration showing a side view of a mobile telephone battery assembly, according to one embodiment of the present invention.

FIG. 5 is an illustration showing a side view of a mobile device, according to one embodiment of the present invention.

FIG. 6 is an illustration showing a side view of a mobile device 600, according to one embodiment of the present invention.

FIG. 7 is an illustration showing a perspective view of a mobile device 700, according to one embodiment of the present invention.

### DETAILED DESCRIPTION OF THE PREFERRED EMBODIMENTS

It should be understood that these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality. In the drawing, like numerals refer to like parts through several views.

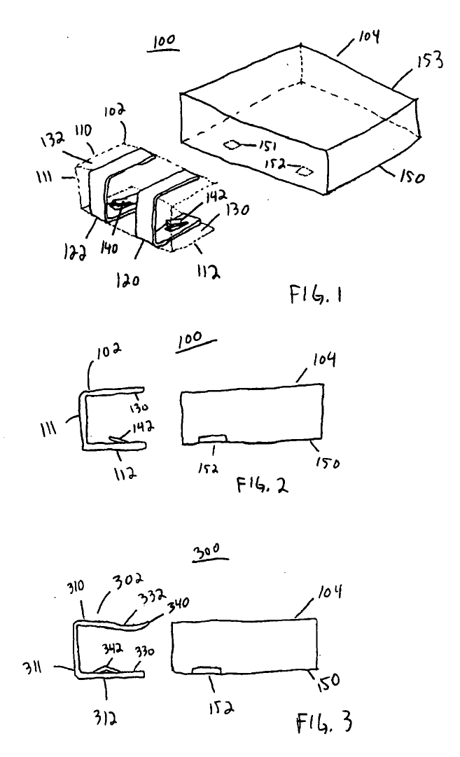

FIG. 1 is an illustration showing a perspective view of a mobile telephone battery assembly 100, according to one embodiment of the present invention. The mobile telephone battery assembly 100 includes a mobile telephone battery 104 having a top side 153 and a bottom side 150. The mobile telephone battery 104 includes two battery contacts 151 and 152 located along the bottom side 150. The battery contacts 151 and 152 can comprise a conductive material such as copper or a copper alloy. The battery contacts 151 and 152 provide access to the current and voltage available within the mobile telephone battery 104.

The mobile telephone battery assembly 100 further includes an interface 102 for the mobile telephone battery 104. The interface 102 comprises a substantially U-shaped element having an interior side 130 and an exterior side 132. The U-shaped element of the interface 102 comprises a first planar element 110, a second planar element 111 connected perpendicularly to the first planar element 110 and a third planar element 112 connected perpendicularly to the second planar element 111, such that the first planar element 110 and the third planar element 112 are parallel.

The interface 102 further includes a conductive element 120 that is located along the first planar element 110, the second planar element 111 and the third planar element 112. The conductive element 120 includes a terminal 142 that is located in the interior 130 of the third planar element 112 of the interface 102. The interface 102 further includes a conductive element 122 that is located along the first planar element 110, the second planar element 111 and the third planar element 112. The conductive element 122 includes a terminal 140 that is located in the interior 130 of the third planar element 112 of the interface 102. The terminals 140 and 142 also comprise a conductive material such as copper or a copper alloy.

The conductive elements 120 and 122 provide a conductive contact along the exterior 132 of the interface 102 in any location a conductive element is present. Thus, the conductive elements 120 and 122 can provide a conductive contact along the exterior 132 of the first planar element 110, the second planar element 111 and the third planar element 112. The conductive elements 120 and 122 comprise a conductive material such as copper or a copper alloy. The conductive elements 120 and 122 provide a conductive contact on the exterior side 132 of the interface 102 for contacting a printed circuit board terminal. A Printed Circuit Board (PCB) is a thin plate on which chips, microprocessors and other electronic components are placed. PCBs are often referred to as boards, cards or adapters.

The mobile telephone battery 104 can be coupled to the interior 130 of the U-shaped element of the interface 102. When the mobile telephone battery 104 is coupled with the interface 102, terminal 140 contacts battery contact 151 of the mobile telephone battery 104 and terminal 142 contacts battery contact 152 of the mobile telephone battery 104. The battery contacts 151 and 152 provide access to the current and voltage available within the mobile telephone battery 104 to terminals 140 and 142, respectively. In turn, the terminals 140 and 142 provide access to the current and voltage available within the mobile telephone battery 104 to conductive elements 122 and 121, respectively.

FIG. 2 is an illustration showing a side view of the mobile telephone battery assembly 100 of FIG. 1, according to one embodiment of the present invention. The mobile telephone battery assembly 100 shows the terminal 142 located in the interior 130 of the third planar element 112 of the interface 102. Note that terminal 142 is an elongated piece of a conductive element that is angled toward the second planar element 111 of the interface 102. The mobile telephone battery assembly 100 also shows the mobile telephone battery 104 with the battery contact 152 located along the bottom side 150 of the mobile telephone battery 104. When the mobile telephone battery 104 is inserted into the interior 130 of the interface 102, the mobile telephone battery 104 fits securely within the interior 130, due to the U-shaped design of the interface 102. Further, the terminal 142, which is angled toward the second planar element 111 of the interface 102, acts like a barb that provides resistance against the movement of the mobile telephone battery 104 in a direction away from the interface 102.

FIG. 3 is an illustration showing a side view of a mobile telephone battery assembly 300, according to one embodiment of the present invention. The mobile telephone battery assembly 300 is almost identical to the mobile telephone battery assembly 100. Like mobile telephone battery assembly 100, the mobile telephone battery assembly 300 includes an interface 302 having an interior side 330 and an exterior side 332, a first planar element 310, a second planar element 311 and a third planar element 312. The interface 302 further includes conductive elements similar to conductive element 120 and conductive element 122. At least one conductive element of interface 302 includes a terminal 342 that is located in the interior 330 of the third planar element 312 of the interface 302.

The mobile telephone battery 104 can be coupled to the interior 330 of the U-shaped element of the interface 302, such that terminal 342 contacts battery contact 152 of the mobile telephone battery 104. The mobile telephone battery assembly 300 shows the terminal 342 located in the interior 330 of the third planar element 312 of the interface 302. Note that terminal 342 is an elongated piece of a conductive element that angles up and then downwards so as to produce a bump or protruding element along the interior 330 of interface 302. Also note that the end 340 of the first planar element 310 of the interface 302 curves downwards and upwards so as to produce a bump or protruding element along the interior 330 of interface 302.

The mobile telephone battery assembly 300 also shows the mobile telephone battery 104 with the battery contact 152 located along the bottom side 150 of the mobile telephone battery 104. When the mobile telephone battery 104 is inserted into the interior 330 of the interface 302, the mobile telephone battery 104 fits securely within the interior 330, due to the U-shaped design of the interface 302. Further, the shape of terminal 342 and the shape of end 340 of first planar element 310 produce a clipping or squeezing force upon the battery 104 that provides resistance against the movement of the mobile telephone battery 104 in a direction away from the interface 302.

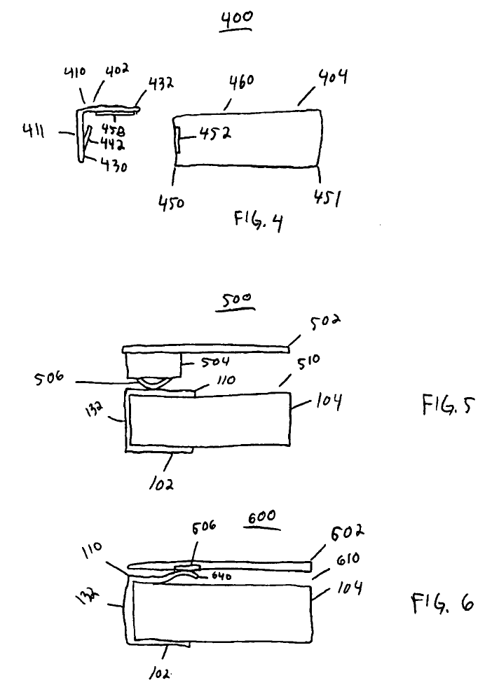

FIG. 4 is an illustration showing a side view of a mobile telephone battery assembly 400, according to one embodiment of the present invention. The mobile telephone battery assembly 400 is similar to the mobile telephone battery assembly 100. Like mobile telephone battery assembly 100, the mobile telephone battery assembly 400 includes a substantially L-shaped interface 402 having an interior side 430 and an exterior side 432, a first planar element 410 and a second planar element 411. The interface 402 further includes conductive elements similar to conductive element 120 and conductive element 122. At least one conductive element of interface 402 includes a terminal 442 that is located in the interior 430 of the second planar element 411 of the interface 402.

The mobile telephone battery 404 includes a left side 450, a right side 451 and a battery contact 452 on the left side 450 of the battery 404. The mobile telephone battery 404 can be coupled to the interior 430 of the L-shaped element of the interface 402, such that terminal 442 contacts battery contact 452 of the mobile telephone battery 404. The mobile telephone battery assembly 400 shows the terminal 442 located in the interior 430 of the second planar element 411 of the interface 402. Note that terminal 442 is an elongated piece of a conductive element that angles up towards the interior 430 of the first planar element 410 of interface 402. Also note adhesive backing 458 located on the interior 430 of first planar element 410 of the interface 402 so as to adhere to the top 460 of the battery 404 when the battery 404 is inserted into the L-shaped interface 402. The adhesion provided by adhesive backing 458 adheres securely onto the top 460 of the battery 104 and provides resistance against the movement of the mobile telephone battery 404 in a direction away from the interface 402.

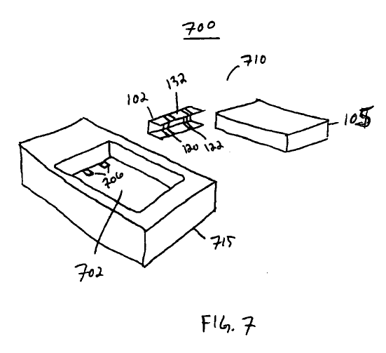

FIG. 5 is an illustration showing a side view of a mobile device 500, according to one embodiment of the present invention. The mobile device 500 includes a mobile telephone battery assembly 510 that is similar to mobile telephone battery assembly 100. Like mobile telephone battery assembly 100, the mobile telephone battery assembly 510 includes an interface 102 and a mobile telephone battery 104 that has been inserted into the interface 102. The mobile device 500 further includes a PCB 502 for a wireless mouse device. The PCB 502 includes an electrical component 504 and a terminal 506 that may comprise a conductive material such as copper or a copper alloy. Note that terminal 506 protrudes so as to facilitate contact with another terminal or contact.

The terminal 506 contacts the exterior 132 of the first planar element 110 of interface 102 such that terminal 506 contacts a conductive element, such as conductive element 120, of interface 102. The conductive element of interface 102 is conductively coupled with terminals, such as terminals 140 and 142, of the interface 102. The terminals of interface 102 are conductively coupled to battery contacts, such as contacts 151 and 152, of battery 104, which provide access to the current and voltage available within the mobile telephone battery 104.

FIG. 6 is an illustration showing a side view of a mobile device 600, according to one embodiment of the present invention. The mobile device 600 includes a mobile telephone battery assembly 610 that is similar to mobile telephone battery assembly 100. Like mobile telephone battery assembly 100, the mobile telephone battery assembly 610 includes an interface 102 and a mobile telephone battery 104 that has been inserted into the interface 102. The mobile device 600 further includes a PCB 602 for a wireless mouse device. The PCB 602 includes contact 606 that may comprise a conductive material such as copper or a copper alloy.

The contact 606 contacts the exterior 132 of the first planar element 110 of interface 102 such that contact 606 contacts a conductive element, such as conductive element 120, of interface 102. The conductive element of interface 102 is conductively coupled with terminals, such as terminals 140 and 142, of the interface 102. The terminals of interface 102 are conductively coupled to battery contacts, such as contacts 151 and 152, of battery 104, which provide access to the current and voltage available within the mobile telephone battery 104.

Note that the end 640 of the first planar element 110 of the interface 102 curves upwards and downwards so as to produce a bump or protruding element along the exterior 132 of interface 102. The end 640 protrudes so as to facilitate contact with contact 606.

FIG. 7 is an illustration showing a perspective view of a mobile device 700, according to one embodiment of the present invention. The mobile device 700 includes a mobile device battery assembly 710 that is similar to mobile telephone battery assembly 100. Like mobile telephone battery assembly 100, the mobile device battery assembly 710 includes an interface 102 and a mobile device battery 105 that has been inserted into the interface 102. The mobile device 700 further includes a PCB 702 for a mobile mouse device 715. The PCB 702 includes at least one terminal 706 that may comprise a conductive material such as copper or a copper alloy.

The at least one terminal 706 contacts the exterior 132 of the interface 102 such that terminal 706 contacts a conductive element, such as conductive elements 120, 122, of interface 102. The conductive elements of interface 102 are conductively coupled with terminals, such as terminals 140 and 142, of the interface 102. The terminals of interface 102 are conductively coupled to battery contacts, such as contacts 151 and 152, of battery 105, which provide access to the current and voltage available within the mobile device battery 105.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

What is claimed is:

1. An interface for a mobile device battery, comprising:
a U-shaped element, including an interior side and an exterior side, wherein a mobile device battery can be coupled to the interior side of the U-shaped element;
at least one terminal coupled to the interior side of the U-shaped element, wherein each terminal contacts a battery contact of the mobile device battery when the mobile device battery is coupled to the interior side of the U-shaped element; and
at least one conductive element, wherein each conductive element is coupled to a terminal and provides a conductive contact on the exterior side of the U-shaped element for contacting a printed circuit board terminal.

2. The interface of claim 1 comprising two terminals coupled to the interior side of the U-shaped element, wherein each terminal contacts a battery contact of the mobile device battery when the mobile device battery is coupled to the interior side of the U-shaped element.

3. The interface of claim 2 comprising two conductive elements, wherein each conductive element is coupled to a terminal and provides a conductive contact on the exterior side of the U-shaped element for contacting a printed circuit board terminal.

4. The interface of claim 1 comprising two conductive elements, wherein each conductive element is coupled to a terminal and provides a conductive contact on the exterior side of the U-shaped element for contacting a printed circuit board terminal.

5. The interface of claim 1, wherein the U-shaped element is comprises a plastic.

6. The interface of claim 1, wherein the at least one terminal comprises copper or a copper alloy.

7. The interface of claim 1, wherein the at least one conductive element comprises copper or a copper alloy.

8. A mobile device battery assembly, comprising:
a mobile device battery including at least one battery contact; and
an interface for the mobile device battery, comprising:
a U-shaped element, including an interior side and an exterior side, wherein the mobile device battery is coupled to the interior side of the U-shaped element;
at least one terminal coupled to the interior side of the U-shaped element, wherein each terminal contacts a battery contact of the mobile device battery; and
at least one conductive element, wherein each conductive element is coupled to a terminal and provides a conductive contact on the exterior side of the U-shaped element for contacting a printed circuit board terminal.

9. The assembly of claim 8, wherein the mobile device battery comprises two battery contacts.

10. The assembly of claim 9 comprising two terminals coupled to the interior side of the U-shaped element, wherein each terminal contacts a battery contact of the mobile device battery.

11. The assembly of claim 10 comprising two conductive elements, wherein each conductive element is coupled to a terminal and provides a conductive contact on the exterior side of the U-shaped element for contacting a printed circuit board terminal.

12. A mobile device, comprising:
a mouse device including a printed circuit board and at least one terminal for the printed circuit board;
a mobile telephone for coupling with the mouse device;
a mobile telephone battery including at least one battery contact; and
an interface for the mobile telephone battery, comprising:
a power-connecting element, including an interior side and an exterior side, wherein the mobile telephone battery is coupled to the interior side of the power-connecting element;
at least one terminal coupled to the interior side of the power-connecting element, wherein each terminal contacts a battery contact of the mobile telephone battery; and
at least one conductive element, wherein said conductive element is coupled to a terminal and provides a conductive contact on the exterior side of the power-connecting element for contacting a terminal for the printed circuit board.

13. The mobile device of claim 12, wherein the mouse device comprises:
a mouse device including a printed circuit board and a terminal for the printed circuit board.

14. The mobile device of claim 13, wherein the mobile telephone battery comprises two battery contacts.

15. The mobile device of claim 14 comprising two terminals coupled to the interior side of the power-connecting element, wherein each terminal contacts a battery contact of the mobile telephone battery.

16. The mobile device of claim 15 comprising two conductive elements, wherein each conductive element is coupled to a terminal and provides a conductive contact on the exterior side of the power-connecting element for contacting a terminal for the printed circuit board.

17. The mobile device of claim 12, wherein the power-connecting element is substantially U-shaped.
